(19) United States
(12) Patent Application Publication
(10) Pub. No.: US 2026/0308937 A1
(43) Pub. Date: Oct. 8, 2026

(54) COMBINATION LOCK WITH CODE RESET FUNCTION

(71) Applicants: S. Franzen Söhne GmbH, Langenfeld (DE); Martin Lehmann GmbH & Co. KG, Minden (DE)

(72) Inventors: Rainer HILLESHEIM, Wuppertal (DE); Jens KRIETE, Minden (DE); Timo NEUMANN, Hüllhorst (DE); Arndt BRANDES, Porta Westfalica (DE)

(73) Assignees: S. Franzen Söhne GmbH, Langenfeld (DE); Martin Lehmann GmbH & Co. KG, Minden (DE)

(21) Appl. No.: 19/481,282

(22) PCT Filed: May 2, 2024
(86) PCT No.: PCT/EP2024/062073

§ 371 Date: Nov. 4, 2025

(30) Foreign Application Priority Data
May 5, 2023 (DE) 10 2023 111 750.5

(51) Int. Cl. E05B 37/00; E05B 37/02

(52) U.S. Cl. CPC E05B 37/0048; E05B 37/0034; E05B 37/02

(57) ABSTRACT

An actuating device for a lock or a lock with setting bushes that are arranged in succession in an axial direction, each cooperate with a number wheel and are each coupled together in a locking position in which the actuation of an actuating element is locked. The setting bushes, concomitantly with rotation of the number wheels into an opening combination, are able to be moved into a release position in which the actuating element is able to be actuated. The number wheels are uncoupled from the setting bushes in a programming position for resetting the opening combination. A programming element, in the programming position, blocks the actuation of the actuating element and which, upon shifting from the programming position into an actuating position in which the setting bushes are coupled to the number wheels, releases the blocking of the blocking element.

### FIELD OF TECHNOLOGY

The invention relates to an actuating device for a lock with axially arranged adjustment sleeves, each cooperating with a number wheel, which are coupled to each other in a locking position in which the actuation of an actuating element is locked are coupled to each other, whereby the adjustment sleeves can be brought into a release position in an opening combination in conjunction with a rotation of the number wheels, in which the actuating element can be actuated, whereby the number wheels are decoupled from the adjusting sleeves in a programming position for changing the opening combination.

### STATE OF THE ART

A device of the type described above is described in DE 10 2014 109 224 A1. The actuating device is part of a combination lock in which, in an initial position, number wheels are uncoupled from their associated adjustment sleeves. The adjustment sleeves assume a release position so that a tumbler interacting with the adjustment sleeves can also assume a release position. The number wheels can be adjusted relative to the individually adjustment sleeves in order to set an opening code. When an actuating element is turned, the adjustment sleeves are coupled with the number wheels. At the same time, the number wheels are moved to a zero position so that the opening code is obscured. To open the lock, the number wheels and the adjustment sleeves coupled to the number wheels must be turned. By setting the opening code with the number wheels, the adjustment sleeves are moved into their release position so that the locking mechanism releases a bolt and the rotary knob can be turned to the open position.

Combination locks are also known from DE 10 2009 016 854 A1, EP 2 419 586 B1 and EP 2 942 457 B1.

### SUMMARY OF THE INVENTION

The invention is based on the task of further developing the combination lock described above in a manner that is advantageous in terms of use.

The task is solved by a programming element. The programming element can be moved from a programming position to an operating position. In the programming position, the number wheels are disengaged from their individually assigned adjustment sleeves. The adjustment sleeves assume their release position. Each adjustment sleeves can have an engagement region, which can be formed in particular by an indentation. An engagement region of the locking device can enter this indentation. The engagement region can be a bulge that enters the indentation. The locking device can be spring-loaded so that the bulge engaging in the indentation holds the adjustment sleeves in the release position.

The programming element may have a blocking element that blocks the operability of the actuating element in the programming position. In the programming position, the number wheels can be turned independently of the adjustment sleeves, so that an opening code can be set by turning the number wheels. The programming element can be moved from the programming position to an actuating position. For this purpose, the programming element may have a switch button with which the programming element can be moved relative to a housing of the actuating device. When the programming element is moved into the actuation position, the adjustment sleeves are coupled in a rotationally fixed manner with their associated number wheels. When the programming element is moved into the actuation position, the locking element also moves out of the locking position so that the actuation element can be moved from the open position into a locking position. The programming element ensures that the actuating element can only be actuated when a new opening code is deliberately stored by coupling the adjustment sleeves with the number wheels. This makes it more difficult for an unwanted opening code to be stored by accidentally actuating the actuating element after adjusting the number wheels from a zero position.

The programming element can be a slider. The switch button can be a protrusion extending from the housing. The slider can have two frame legs running parallel to each other, which are connected to each other by cross legs that also run parallel to each other. The setting wheels (adjustment sleeves) with their associated number wheels can be arranged in this frame formed by the frame legs and the cross legs. The programming element is preferably moved in a direction parallel to the axis around which the adjustment sleeves or number wheels can be rotated. According to a preferred embodiment, a spring element is provided to hold the programming element in the programming position. The spring element preferably acts on the blocking element, which may be a projection, in its blocking position. The projection forming the blocking element may lie in a recess of a control body in the programming position. The control body may be a cylindrical sleeve that is rotatably associated with the actuating element. The actuating element is preferably a rotary knob that can be turned about a rotational axis. The control body may be associated with the rotary knob in such a way that it can be displaced in the direction of this rotational axis. A spring element may be provided to act on the control body. If the projection of the programming element engages in the recess of the control sleeve, the rotary knob cannot be rotated. If the programming element is moved to the actuating position, the projection can emerge from the recess. The rotary knob can now be moved.

The control sleeve may have a cylinder surface that connects to the recess in the circumferential direction around the axis of rotation of the rotary knob. After slightly turning the rotary knob from the open position, the projection can rest on this cylindrical surface. This prevents the programming element from moving back from the actuating position to the programming position. When the rotary knob is turned from the open position to the locking position, the projection is guided along this cylindrical surface.

As it moves from the open position to the locked position, the rotary knob controls a zeroing device. The zeroing device has a number of reset arms that can engage with heart-shaped control cams on the number wheels to bring the number wheels into a starting position, for example, a position in which the number zero is displayed. As the number wheels are adjusted, the adjustment sleeves are also adjusted because they are rotationally coupled to the number wheels. This obscures the opening code. As the adjustment sleeves are turned, the bulges of the tumbler also emerge from the indentations of the setting bushings. To reduce the force required, the tumbler, which is preferably designed as a rocker, is moved from the release position to a locking position immediately before the zero position. This is achieved by a plunger or tappet that acts on an arm of the rocker and is moved by a control cam of the rotary knob. The plunger or tappet can be moved parallel to the axis of rotation of the rotary knob and has a first end that engages with the arm of the rocker and a second end that is supported by a control cam of the rotary knob when the tappet is moved. The rotary knob thus has a control ramp that is capable of acting on the tappet to pivot the latch in an axial direction relative to the axis of rotation of the rotary knob. The control ramp can be formed by a control projection. The control ramp can be followed by a control flank along which the second end of the tappet can slide when the zero adjuster moves the number wheels to the zero position.

The zeroing device may have an actuating pin that can slide along a control cam on the rotary knob. The control cam is designed in such a way that the zeroing device is actuated both when the rotary knob is turned from the open position to the locked position and when the rotary knob is turned from the locked position to the open position.

The locking device may have a recess into which a bolt arranged in the rotary knob engages. The bolt can deflect against the restoring force of a spring in a radially inward direction relative to the axis of rotation of the rotary knob. It can thus also enter the recess when the locking device is in the locked position. For this purpose, one end of the bolt can slide along one side of the locking device and deflect into a cavity in the rotary knob.

An additional lock may be provided, which when activated allows the bolt to be actively pulled out of the recess in the tumbler, so that the rotary knob can be turned even if the opening code is not set correctly. The additional lock has a lock cylinder which is arranged in the rotary knob.

If the rotary knob is turned from the locked position to the open position either when the opening code is set correctly or when the bolt is retracted, a cam arrangement associated with the control sleeve comes into effect. This cam arrangement has a cam that runs at an angle relative to the plane of rotation of the rotary knob and interacts with the projection of the programming slider in such a way that the control sleeve is displaced in the axial direction against the restoring force of the spring acting on it. The projection of the programming slider may have one or more bevels that can slide along the control cam to displace the control sleeve. The projection of the programming slider or the bevel formed by it and the control cam are designed in such a way that immediately after the rotary knob begins to turn from the locked position, the control sleeve is lifted until the projection of the programming slider passes under the lower edge of the control sleeve. This causes the programming slide to move from the operating position to the programming position. At the same time, the adjustment sleeves are moved from their coupling position to the respective number wheels, which means that the adjustment sleeves can be turned independently of the number wheels. In the locking position, the projection of the programming element can rest in a recess in the outer wall of the control body. When entering this recess, the programming element can shift slightly towards the programming position, but not in such a way that the coupling position between the adjustment sleeves and the number wheels is lost. The edges of this recess form the control cam with which the adjustment sleeve is shifted in the axial direction.

Both the number wheels and the adjustment sleeves have heart-shaped control cams that can interact with a reset arm of the zeroing device. While the heart-shaped curves of the number wheels can be acted upon by the return arms both in the programming position and in the actuating position, the heart-shaped curves of the adjustment sleeves can only be acted upon by the return arms in the decoupled position, which is axially displaced relative to the coupling position. As a result, when the rotary knob is turned from the locked position to the open position, not only the number wheels but also the adjustment sleeves are moved to their initial position. The number wheels are moved to the zero position and the adjustment sleeves to the release position.

The adjustment sleeves are arranged on an axle so that they can be moved axially. Both ends of the axle are mounted in the housing. The adjustment sleeves have a middle section that forms the heart curve and has a bulge axially adjacent to it. The number wheel assigned to the adjustment sleeves sits on a sleeve-shaped extension and has coupling pins extending in the axial direction, which can enter the coupling openings of the adjustment sleeves. An axially shorter extension of the adjustment sleeve is located on the opposite side. One end face of the axially shorter extension rests against one end face of the axially longer extension of an adjacent adjustment sleeve. A spring element engaging at one end face of a longer extension can thus move all adjustment sleeves simultaneously into the programming position, in which the adjustment sleeves are disengaged from the number wheels. One end face of an adjustment sleeve on the other side can be supported on a crossbar of the programming slide in order to apply the programming slide to the programming position.

It is considered advantageous if a spring element acting on the adjustment sleeves arranged axially one behind the other acts on a blocking element in an active position in which a zero position is prevented by actuating an actuating element, so that the zero position can only be achieved after the actuating element has been actuated if a new opening code is deliberately stored by moving a programming element into an actuating position.

### BRIEF DESCRIPTION OF THE DRAWINGS

An embodiment of the invention is explained below with reference to the accompanying drawings. They show:

FIG. 1 a perspective view of a combination lock with an actuating device according to the invention,

FIG. 2 the section along line II-II in FIG. 1 in an open position of a rotary knob 11,

FIG. 3 the section along line III-III in FIG. 2 in a programming position of a programming slider 7,

FIG. 4 the section along line IV-IV in FIG. 2,

FIG. 5 the section along line V-V in FIG. 2,

FIG. 6 the section along line VI-VI in FIG. 2,

FIG. 7 perspective view of the lock mechanism, broken open in the area of an adjustment sleeve 3,

FIG. 8 a view in an operating position in which the rotary knob 11 has been turned from its open position towards a locking position and in which a zeroing device 21 assumes an actuating position,

FIG. 9 shows the section along line IX-IX in FIG. 8,

FIG. 10 the section along line X-X in FIG. 9,

FIG. 11 a section along line XI-XI in FIG. 10, but in an operating position in which the rotary knob 11 has been turned slightly towards the locking position,

FIG. 12 shows a view of rotary knob 11 in which zeroing device 21 is in its functional position,

FIG. 13 shows the section along line XIII-XIII in FIG. 12,

FIG. 14 the cut according to line XIV-XIV in FIG. 10, wherein a heart curve 32 of the number wheel 2 is acted upon by an arm 44 of a zeroing device 21 in a reset position,

FIG. 15 shows a representation according to FIG. 11, but with the actuating pin 21′ of a zeroing device 21 in a functional position,

FIG. 16 shows a section according to FIG. 4, but with the number wheel 2 rotated,

FIG. 17 shows a section similar to FIG. 6, but with rotated knob 11, wherein the head of a bolt 24 rests against an edge 26 of an arm of the locking device 6,

FIG. 18 shows a view according to FIG. 15, wherein the rotary knob 11 has been further rotated in the direction of the locking position,

FIG. 19 shows a representation according to FIG. 17, but in the rotary position according to FIG. 18,

FIG. 20 shows a view according to FIG. 19, but with the rotary knob 11 turned further into the locking position, in which the head of the bolt 24 is immersed in a recess 25 in the arm of the locking device 6,

FIG. 21 shows a representation according to FIG. 18, but in the rotary position according to FIG. 20,

FIG. 22 shows a view according to FIG. 2, but in the locked position, in which an end face of the projection 8 of the programming slider 7 rests on a bottom surface 48′ of a recess 48,

FIG. 23 shows a sectional view through the rotary knob 11 similar to FIG. 22, but with a key inserted into a key channel of a cylinder core 41, whereby the tumbler 6 assumes its locking position.

FIG. 24 shows a view similar to FIG. 21, but with rotary knob 11 turned back slightly from the locking position, whereby control sleeve 10 is raised slightly upwards from projection 8 by sliding along a control cam 19.

FIG. 25 shows a view according to FIG. 24, wherein the rotary knob 11 has been turned slightly further and the projection 8 has moved under a lower edge 18′ of the control sleeve 10,

FIG. 26 shows a section similar to FIG. 22, but in an operating position as shown in FIG. 25, with the programming slider 7 having moved towards the rotary knob 11,

FIG. 27 shows a representation according to FIG. 25, but with the rotary knob 11 turned further in the direction of the open position,

FIG. 28 shows a view according to FIG. 14, but as an intermediate position of the rotary knob 11 during its movement from the locked position to the open position,

FIG. 29 shows a parallel section to the section shown in FIG. 28 to illustrate the effect of the return arm 44 of the zeroing device 21 on a heart curve 33 of the adjusting bushing 3 for moving the adjusting bushing 3 into its release position,

FIG. 30 shows a first exploded view of the components of the device,

FIG. 31 shows a second exploded view of the components of the device,

FIG. 32 shows an enlarged exploded view of the number wheels 2 and the adjustment sleeves 3 assigned to them,

FIG. 33 a view according to FIG. 32 to illustrate the rear sides of the number wheels 2 and the adjustment sleeves 3,

FIG. 34 shows a top view of the rotary knob 11,

FIG. 35 is a view in accordance with arrow XXXV in FIG. 34,

FIG. 36 the view according to arrow XXXVI in FIG. 34,

FIG. 37 the view according to arrow XXXVII in FIG. 34,

FIG. 38 the view according to arrow XXXVIII in FIG. 34,

FIG. 39 the view according to arrow XXXIX in FIG. 34,

FIG. 40 a representation similar to FIG. 7, wherein the rotary knob 11 assumes its locking position,

FIG. 41 shows another perspective view in which the rotary knob 11 is in its locked position,

FIG. 42 shows a perspective view of the programming slider 7, the locking device 6, the zeroing device 21, a leaf spring element 46, a base body 49 of the rotary knob 11 and a housing 1,

FIG. 43 shows a representation similar to FIG. 7, but with the programming slider 7 and number wheels 2 omitted and the adjustment sleeves 3 in a rest position of the zeroing device 21,

FIG. 44 shows a representation in accordance with FIG. 43, but with the zeroing device 21 actuated and

FIG. 45A representation similar to FIG. 44, but with the key inserted in the key channel of the additional lock 38.

### DESCRIPTION OF THE EMBODIMENTS

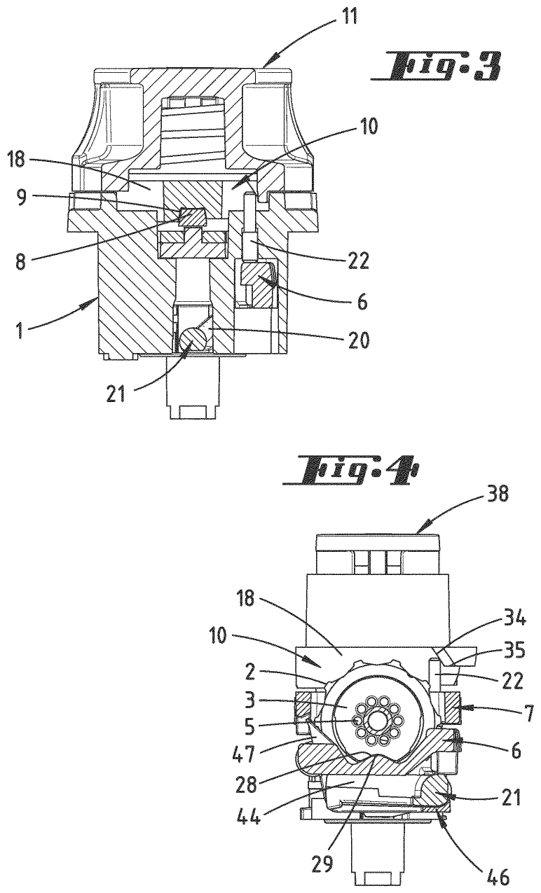

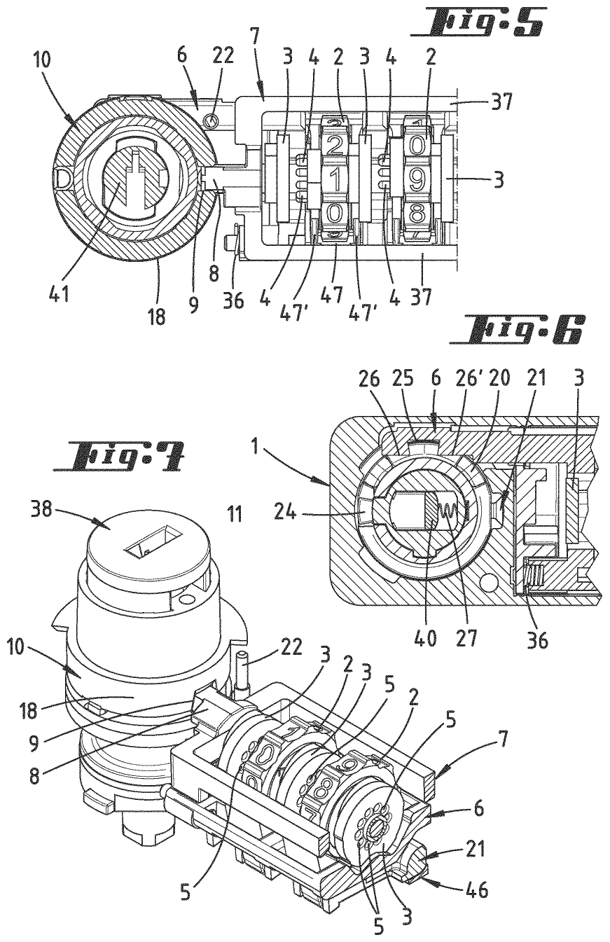

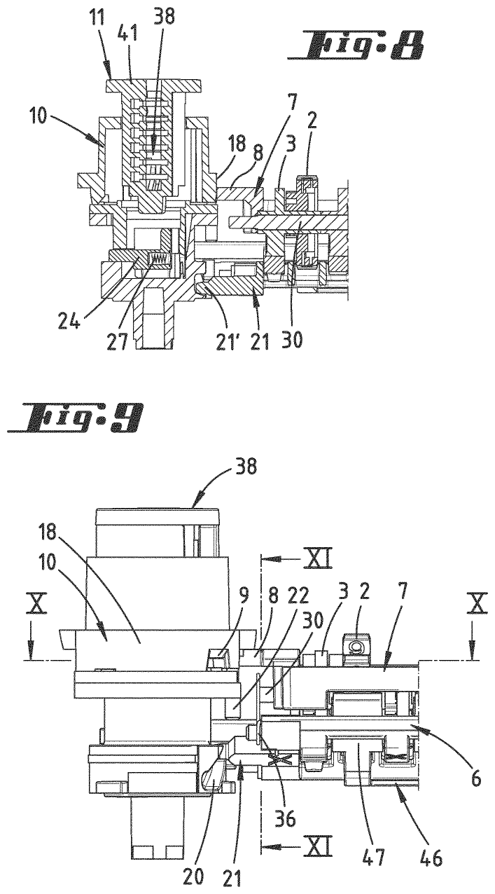

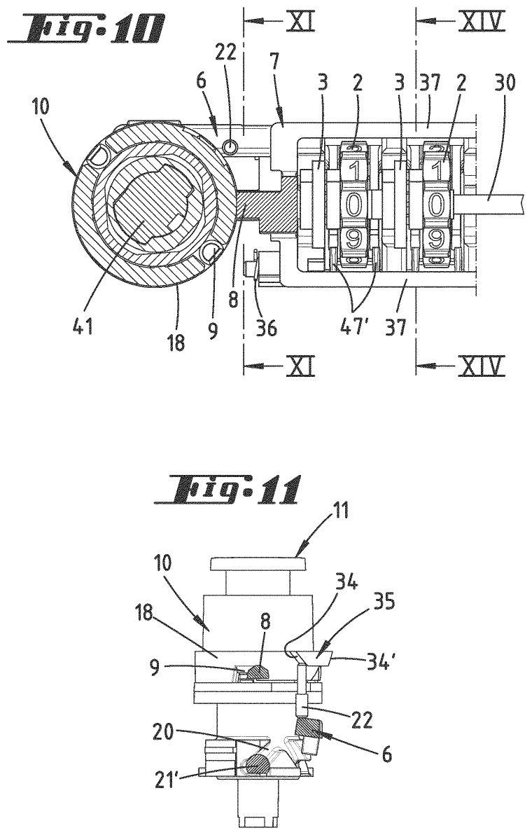

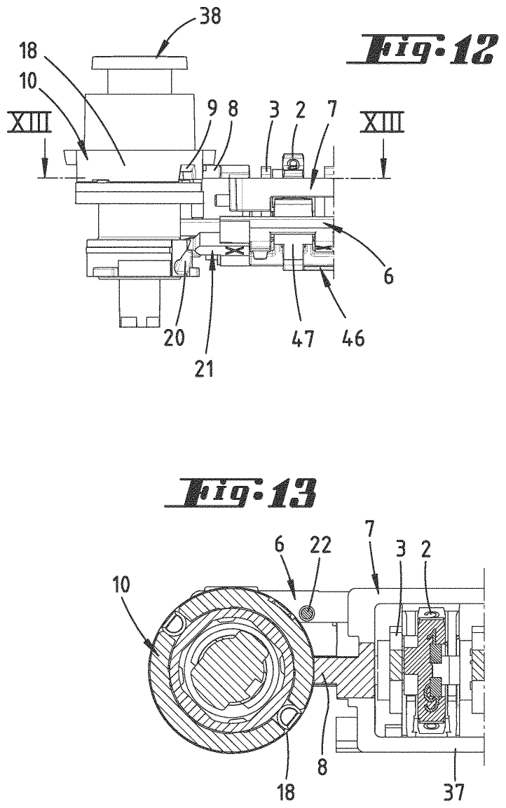

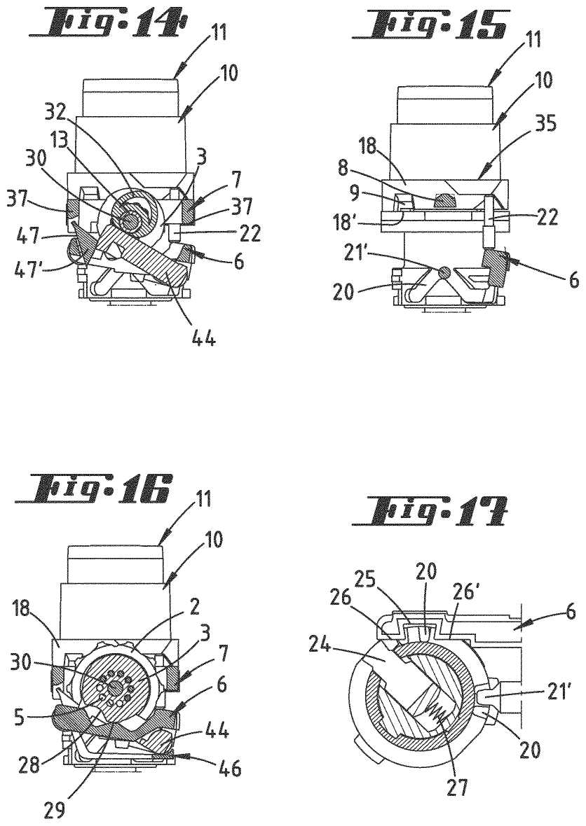

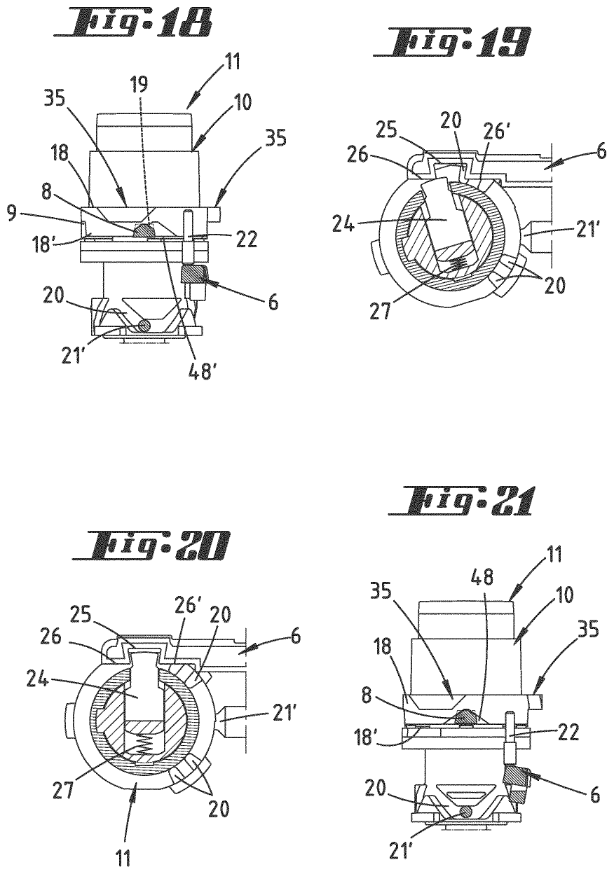

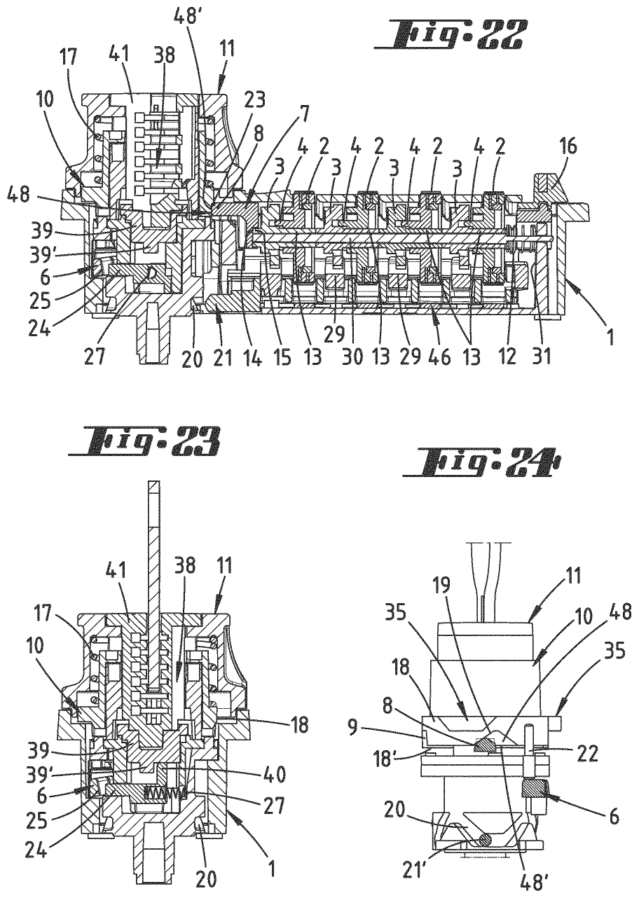

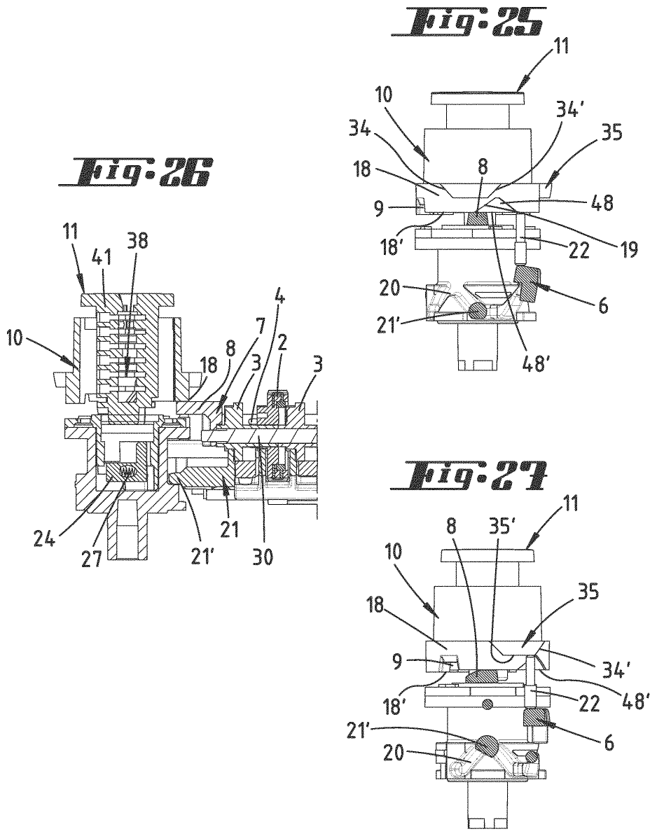

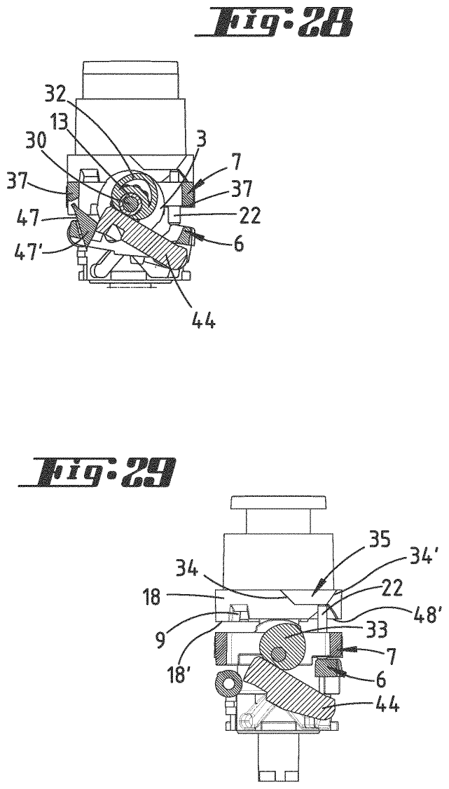

The device shown in the drawings is a combination lock. The combination lock has a housing 1 in which an actuating device is arranged. The actuating device has a rotary knob 11 which is rotatably mounted in the housing 1. The rotary knob 11 has an additional lock 38, which has a cylinder core 41 with a keyway into which a matching key can be inserted in order to retract a bolt 24 by turning the cylinder core 41 and an actuating element 39 coupled to the cylinder core 41. For this purpose, an actuating pin 39′ of the actuating element 39 engages with a projection 40 of the bolt 24 in order to retract the bolt 24 from the locked position shown in FIG. 2. In doing so, a spring 27, which in the embodiment is a helical compression spring, is tensioned. The bolt 24 can also be moved by applying radial pressure against the restoring force of the spring 27.

The rotary knob 1 has an upper base body 50 and a lower base body 49. On the outer wall of the upper base body 50 of the rotary knob 11 there is a control body which is designed as a control sleeve 10. The control sleeve 10 is connected to the base body 50 of the rotary knob 11 in such a way that it cannot rotate. For this purpose, radial wings of the control sleeve 10 protrude into recesses in the base body 50. The control sleeve 10 can be displaced axially in the direction of the axis of rotation of the rotary knob 11. This is done against the restoring force of a spring element 17. The control sleeve 10 can be supported on an upper end face of the lower base body 49, which is connected in a rotationally fixed manner to the upper base body 50. This can be done with a lower edge 18′.

The control sleeve 10 has a recess 9 that is open towards the lower edge 18′ of the control sleeve 10. The recess 9 is connected in a circumferential direction, relative to the axis of rotation, to a cylindrical surface 18 and has a trapezoidal ground plan. The cylindrical surface 18 is followed by a cam arrangement which has an inclined cam 19. In the embodiment, the cam arrangement 2 has two cams 19 which are arranged like a roof. The cams are formed by the edges of a recess 48 which has a base surface 48′.

The control sleeve 10 also has two diametrically opposed control projections 35, each of which has a control bevel 34, 34′ running at an angle to a plane of rotation of the rotary knob 11 and a control flank 35′ lying in the plane of rotation of the rotary knob 11.

An axle 30 is mounted in the housing 1, which supports four adjustment sleeves 3 arranged axially one behind the other. The adjustment sleeves 3 can be rotated independently of each other around the axle 30. Each adjustment sleeve 3 has a central section that forms an indentation 28. A heart curve 33 is adjacent to this section. The adjustment sleeve 3 also has an extension 13, which has a sleeve shape and on which a number wheel 2 is mounted. A shorter sleeve-shaped extension 15 is located on the other side. One end of a short sleeve-shaped extension 15 rests against one end of a long sleeve-shaped extension 13. One end of a long sleeve-shaped extension 13 of an outer adjustment sleeve 3 is acted upon by a spring element 12, which is supported by a housing wall 31. The front end of a shorter sleeve-shaped extension 15 of another outer adjustment sleeve 3 is supported by a stop 14 of a crossbar of a programming slide 7.

A broad surface of the adjustment sleeve 3 has coupling openings 5 into which coupling pins 4 of the number wheel 2 associated with the adjustment sleeve 3 can engage in a coupling position, so that the adjusting bushing 3 is coupled to the number wheel 2 in a rotationally fixed manner. In a disengaged position, the coupling pins 4 are completely withdrawn from the coupling openings 5, so that the adjustment sleeves 3 and the number wheels 2 can be rotated independently of each other about the axis 30.

The number wheels 2 have numbers from zero to nine on their circumferential surface. They also have an additional heart curve 32.

A zeroing device 21 is mounted in the housing 1. The zeroing device 21 has an axis 45 around which the zeroing device 21 can be rotated. The zeroing device 21 has an actuating pin 21′ which acts as a lever arm to rotate the zeroing device 21 about the axis 45. The zeroing device 21 has a plurality of return arms 44 which protrude radially from the axis 45 in relation to the axis 45. Every second return arm 44 interacts with the heart curve 32 of the number wheel 2 or with the heart curve 33 of the adjustment sleeve 3. Since the adjustment sleeve 3 can be moved axially, the heart curve 33 of an adjustment sleeve 3 only interacts with an associated return arm 44 in the disengaged position.

The lower base body 49 of the rotary knob 11 has a control cam 20 which interacts with the actuating pin 21′ of the zero reset device 21 in order to actuate the zero reset device 21 when the rotary knob 11 is turned. The control cam 20 consists of two control slopes 21a, 21b, which are arranged in a roof-like manner relative to each other. The control slopes are formed by the walls of a control groove.

A leaf spring element 46 is also mounted in the housing 1, which forms spring arms 47 with projections 47′ that interact with the number wheels 2 to hold the number wheels 2 in different positions.

A locking device 6 is arranged in the housing 1, which can be pivoted as a rocker about an axis 42. The locking device 6 has a recess 25 into which the bolt 24 can engage in the locked position. The locking device 6 is held by a spring element 36 in a release position in which the recess 25 is not located in the same plane of rotation as the rotary knob 11 in which the bolt 24 is located, so that the rotary knob 11 can be turned. In a locking position of the tumbler 6, the recess 25 is located in the plane of rotation of the bolt 24, so that the rotary knob 11 cannot be turned. The recess 25 is adjacent to flanks 26, 26′, against which the bolt 24 can press when the rotary knob is moved into the locking position in a locking position of the tumbler 6. Then, depending on the direction of rotation of the rotary knob 11, the bolt can slide off one of the flanks 26, 26′.

The locking device 6 has a bulge 29 assigned to each adjustment sleeve 3, which can engage in the respective indentation 28 of the adjustment sleeve 3. If all adjustment sleeves 3 are in an operating position in which the indentations 28 face the bulges 29, the locking device 6 can assume its release position. The locking device 6 assumes its locking position as soon as one of the adjustment sleeves 3 is not in this position. The bulges 29 are each formed by arms 43.

The locking device 6 interacts with a plunger or tappet 22, which engages with the arm of the locking device 6 that forms the recess 25. A lower end of the tappet 22 can be supported on this arm. An upper end of the tappet 22, which extends parallel to the axis of rotation of the rotary knob 11, can be acted upon by the control ramp 34, 34′ or the control flank 35′ of the control projection 35.

The number wheels 2 are located in a space of a programming slide 7 bounded by frame legs 37. The programming slide 7 forms a stop 14 with a transverse leg, on which the adjustment sleeve 3 can be supported. The stop 14 is acted upon by the spring element 12, which is supported on the housing wall 31, via the adjustment sleeves 3 arranged axially one behind the other. The programming slider 7 has a projection 8 at its end adjacent to the rotary knob 11 and a switch button 16 protruding from the housing at its end remote from the rotary knob 11. The programming slider 7 can be moved in a direction parallel to the axis 30 or transverse to the axis of rotation of the rotary knob 11.

The projection 8 has two roof-like slopes 8′ at its outermost free end, which can interact with the control cams 19 of the recess 48.

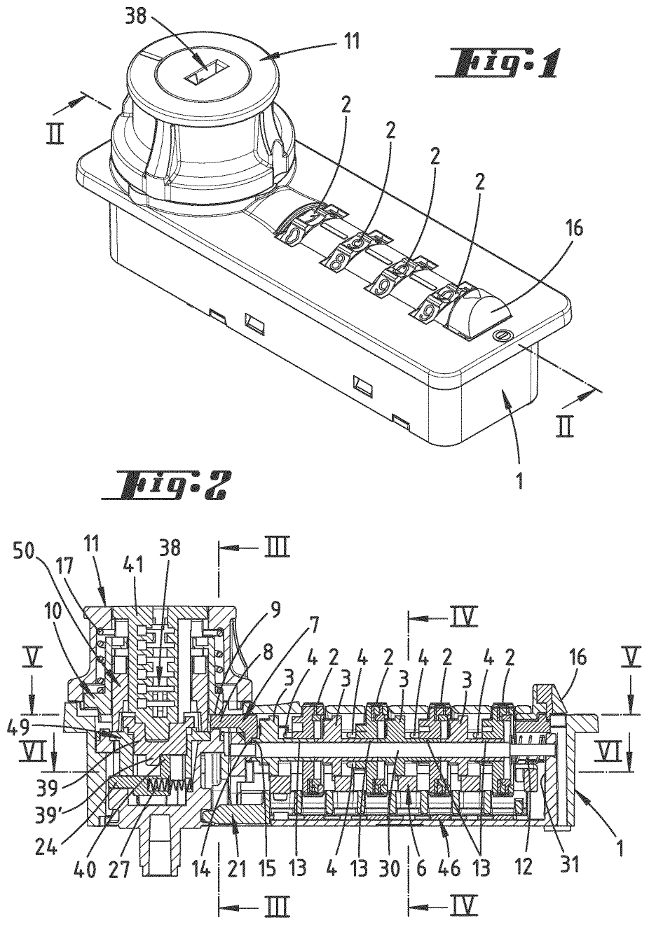

The device functions as follows:
In an open position of the lock shown in FIGS. 1 to 7, the adjustment sleeves 3 are in a position disengaged from the number wheels 2. The adjustment sleeves 3 assume their release position, in which the protrusions 9 of the locking device 6 engage in the recesses 28 of the adjustment sleeves 3, thus holding the adjustment sleeves 3 in their release position. The number wheels 2 can be adjusted relative to the adjustment sleeves 3 so that an individual opening code can be set. The adjusting bushings 3 are held in the disengaged programming position by the spring element 12.

The projection 8 of the programming slider 7 engages in the recess 9 of the control sleeve 10, thereby blocking its rotation. Since the control sleeve 10 is connected to the rotary knob 11 in a rotationally fixed manner, the rotary knob 11 cannot be turned in the programming position shown in FIGS. 1 to 7. The rotary knob 11 cannot therefore be turned.

FIG. 4 shows how the locking device 6 engages with the bulge 29 in the recess 28 of an adjustment sleeve 3, thereby assuming a release position.

If the switch button 16 is removed from the rotary knob 11 starting from this programming position, the programming slider 7 is moved from the programming position to an actuating position in which the projection 8 has emerged from the recess 9. In this position, the rotary knob 11 can be turned. During the movement of the programming slider 7 from the programming position to the position shown in FIGS. 8 and 9, the adjustment sleeves 3 are coupled with the number wheels 2 so that the opening code is set. The rotary knob 11 can therefore only be turned if the programming slider 7 has been deliberately moved into the operating position. This prevents the device from being accidentally programmed with a random, unintentionally set code.

After a slight turn of the rotary knob 11, the actuating pin 21′ of the zeroing device 21 enters the area of the control cam 20. As shown in FIGS. 11 and 12, the actuating pin 21′ slides along the control cam 20 and moves the zeroing device 21 in such a way that every second arm 44 of the zeroing device 21 engages with a heart curve 32 of the number wheel 2 in order to move the number wheel 2 together with the adjustment sleeve 3 coupled to the number wheel 2 into a neutral position. This is illustrated in FIGS. 14 and 15.

With a slight advance, the control ramp 34 of the control projection 35 acts on the upper end face of the tappet 22, which is supported on the rocker arm of the locking device 6, in order to move the bulge 29 out of the recess 28 before zeroing. At the same time, the locking device 6 moves into its locking position so that the recess 25 is located in the plane of rotation of the bolt 24. When the rotary knob 11 is turned further in the direction of the locking position, the bolt 24 slides along the flank 26, 26′ and moves against the restoring force of the spring 27 until it can enter the recess 25 when it reaches the locking position (see FIGS. 17 and 19).

Shortly before reaching the locking position, the front surface of the projection 8 overruns an edge of the recess 48 (see FIG. 18). This edge forms one of the cams 19. The width of the edge corresponds to the depth of the recess 48. When crossing the edge (see FIG. 21), the programming slider 7 is shifted slightly towards its programming position. However, the shift is so small that the coupling pins 4 cannot emerge from the coupling openings 5. The coupling position between the number wheels 2 and the adjustment sleeves 3 is thus maintained.

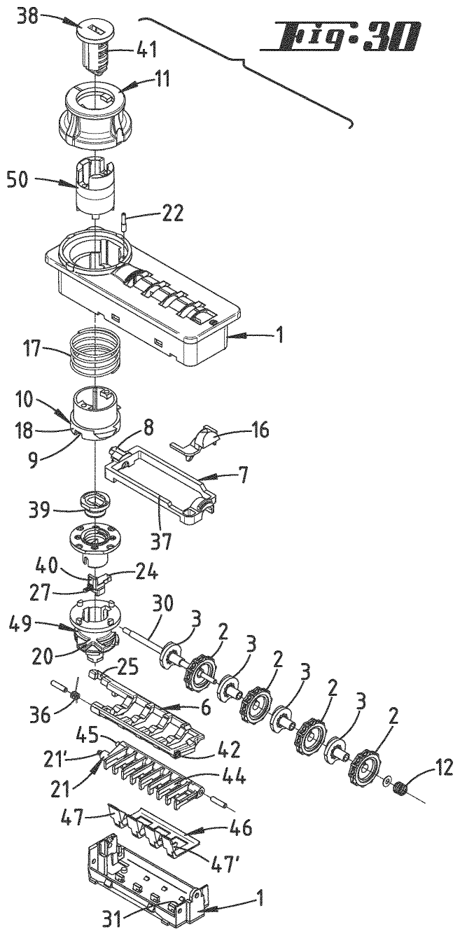

In the locked position (FIGS. 20 to 23), the front end of the projection 8 rests on a base surface 48′ of the recess 48 formed by the two control cams 19. From this position, the rotary knob can be turned both clockwise and counter-clockwise towards an open position.

To open the lock, either the additional lock 38 must be operated with a suitable key so that the bolt 24 is retracted, or the number wheels 2 must be turned to a position corresponding to the opening code so that the tumbler 6 assumes its release position.

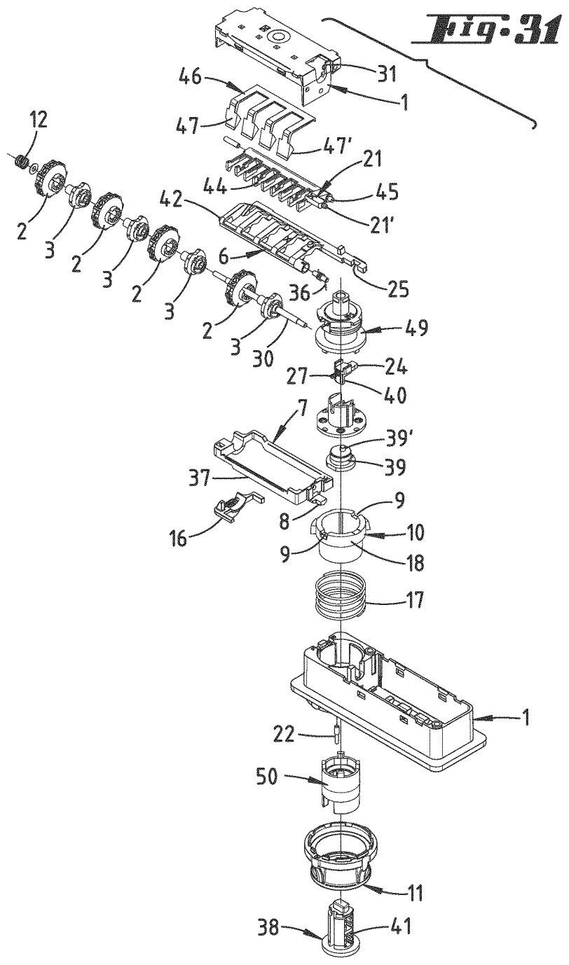

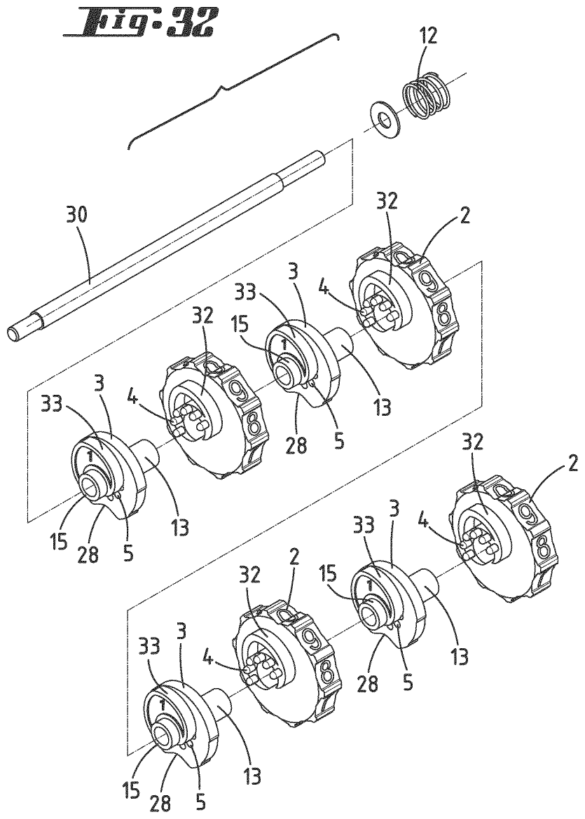

Immediately after the rotary knob 11 begins to turn towards the open position (see FIG. 24), the free end of the projection 8, i.e. in particular the bevel 8′, comes into contact with the control cam 19, which runs diagonally opposite the plane of rotation of the rotary knob 11. As a result, the control sleeve 10 moves against the restoring force of the spring element 17 until the free end of the projection 8 comes under the lower edge 18′ of the cylinder surface or the control sleeve 10 (see FIG. 25). This in turn causes the programming slider 7 to shift radially towards the axis of rotation relative to the axis of rotation of the rotary knob 11. The driving force is the spring 12 acting on the adjustment sleeves 3, so that the adjusting bushings 3 move into a position disengaged from the number wheels 2 (see FIG. 26).

When the rotary knob 11 is turned further from this rotary position, the tappet 22 can pass under the control projection 35 in order, for example, to pivot the latch 6.

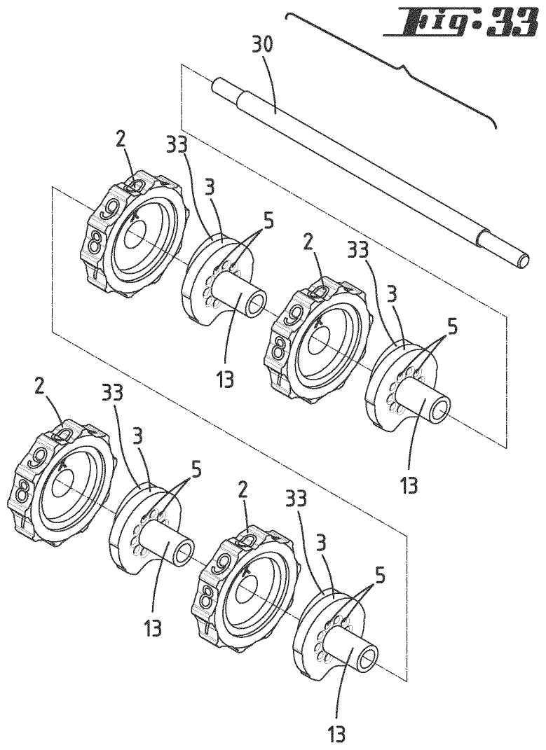

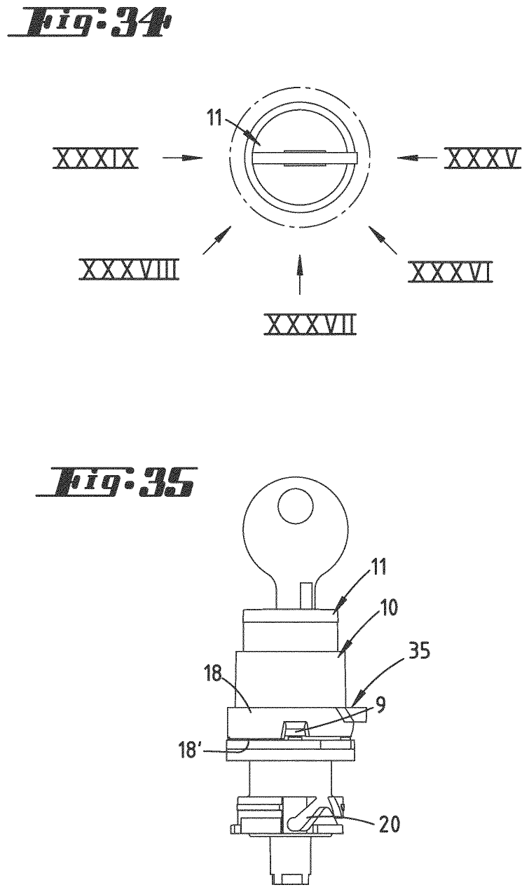

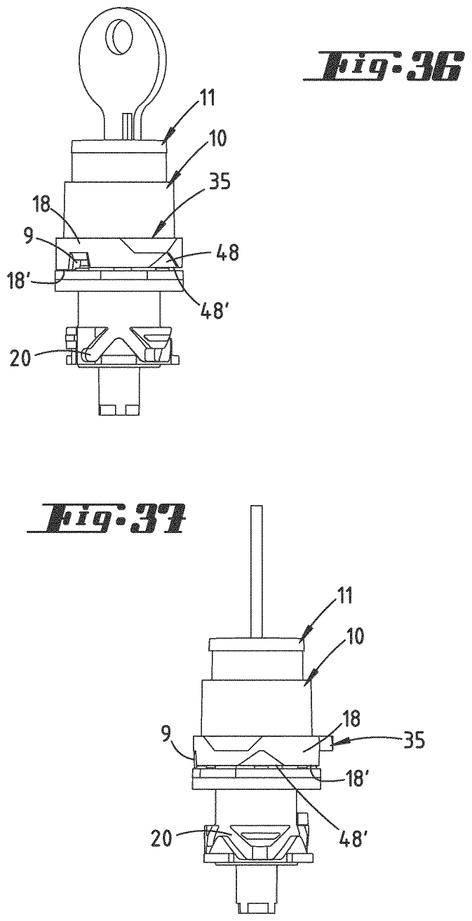

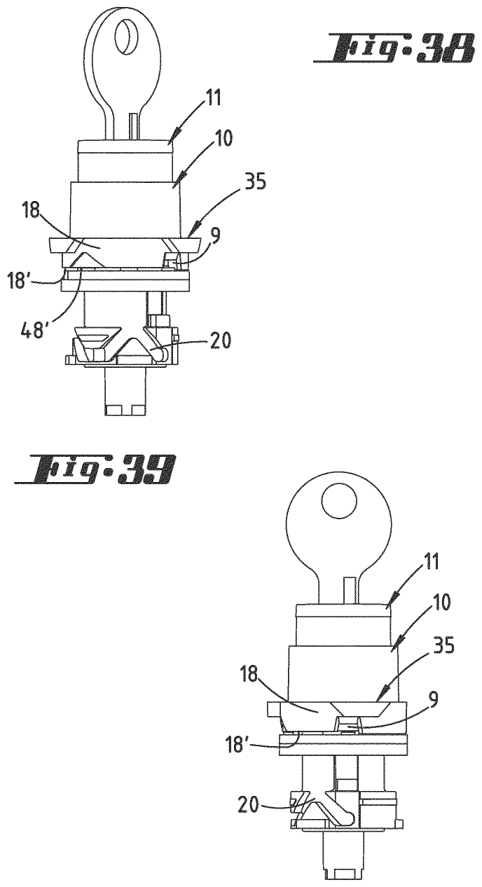

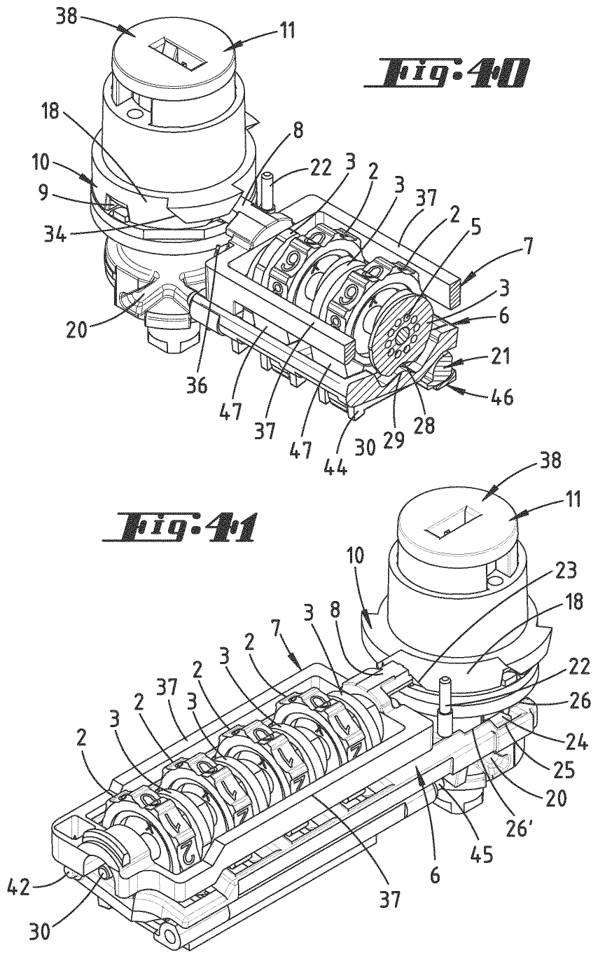

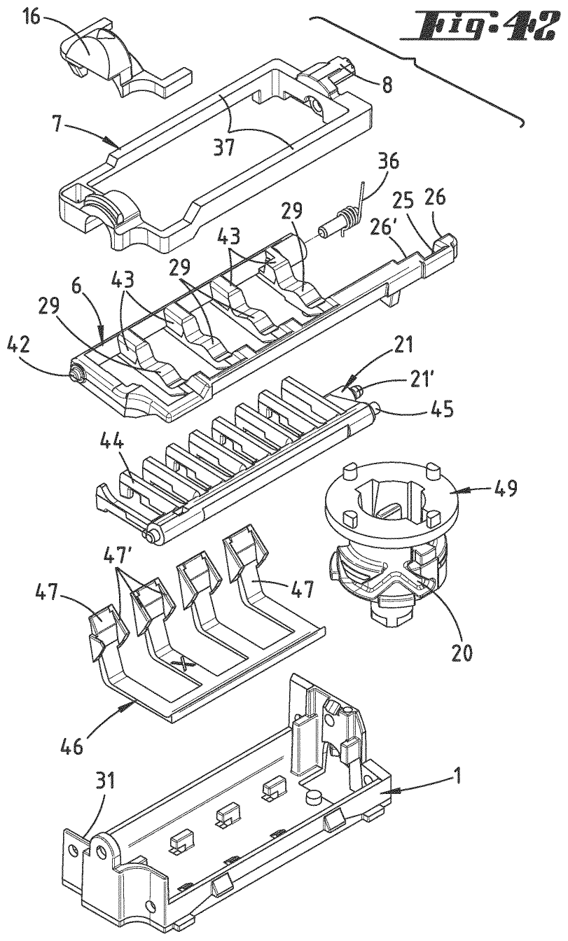

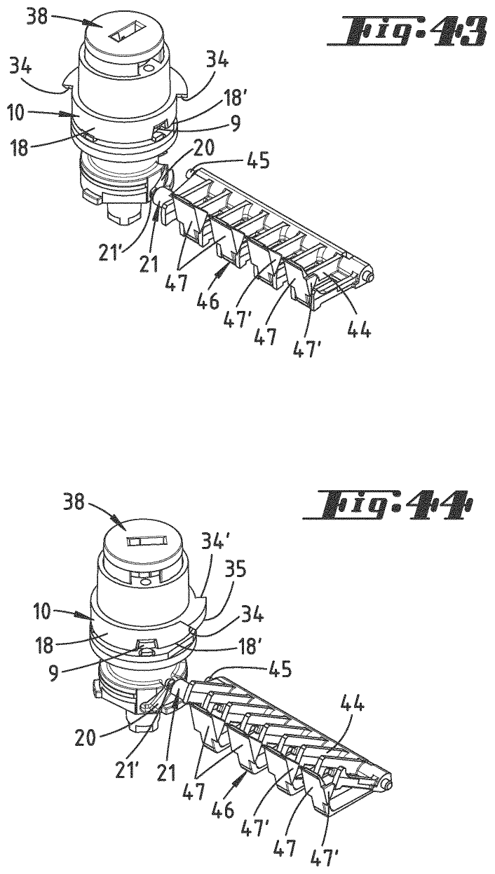

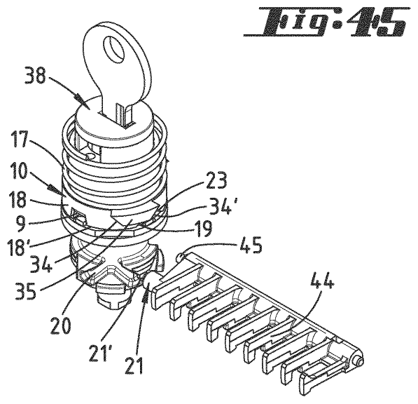

When the rotary knob 11 is turned further, the actuating pin 21 passes through the control cam 20, so that the zeroing device 21 is actuated. Since the return arms 44 are now in the area of the heart curves 33 of the adjustment sleeves 3, not only are the number wheels 2 (see FIG. 28) moved to the neutral position, but the adjustment sleeves 3 (see FIG. 29) are also moved to the release position.

When the rotary knob 11 reaches its open position at the end of its rotary movement, the projection 8 is located under the recess 9, so that the control sleeve 10 is returned to the initial position shown in FIG. 2 by the force of the spring element 17.

The invention improves the operational reliability of an actuating device or a closure according to the invention which has such an actuating device. It prevents the unintentional coding of a code that has not been deliberately set, i.e. that has not been noticed by the person setting it, simply by operating the rotary knob. This disadvantage is eliminated by the fact that the operating element 11 can only be operated from an open position of the lock if the opening code is stored.

The above explanations serve to illustrate the inventions covered by the application as a whole, which independently advance the state of the art at least through the following combinations of features, whereby two, several or all of these combinations of features may also be combined, namely:

An actuating device, characterized by a programming element 7 which, in the programming position, blocks the actuation of the actuating element 11 and, when moved from the programming position to an actuating position in which the adjustment sleeves 3 are coupled to the number wheels 2, releases the blockage of the blocking element 11.

An actuating device, characterized in that the programming element 7 is a slider that can be moved in the axial direction and has a switch button 16 protruding from a housing 1.

An actuating device, characterized in that the programming element 7 is acted upon by a spring element 12 in the programming position and/or forms a projection 8 which, in the programming position, rests in a recess 9 of a control body 10.

An actuating device, characterized in that the control body 10 is a control sleeve 10 connected in a rotationally fixed manner to a rotary knob 11 forming the actuating element, wherein the rotary knob 11 can be locked in rotation by a projection 8 of the programming element 11 engaging in the recess 9 of the control sleeve 10.

An actuating device, characterized in that the control sleeve 10 has a cylindrical surface 18 which connects to the recess 9 in the circumferential direction around a rotational axis of the rotary knob 11 and along which the projection 8 slides when the rotary knob 11 is rotated from an open position into the locking position.

An actuating device, characterized in that the control sleeve 10 has a control cam 19 which is designed in such a way that the projection 8, which slides along the control cam 19 when the rotary knob 11 is turned from the locked position to the open position, displaces the control sleeve 10 axially against the restoring force of a spring element 17 in such a way that the projection 8 engages under an edge 18′ of the control sleeve 10 and thereby changes the programming element 7 from the actuating position to the programming position.

An actuating device characterized in that, after the programming element 7 has been moved into the programming position, when the rotary knob 11 is turned further in the direction of the open position, a further control cam 20 of the rotary knob 11 displaces a zeroing device 21, which, with the zeroing device, moves the adjustment sleeves 3 into the release position and the number wheels 2 decoupled from them into a zero position.

An actuating device, characterized in that, when the rotary knob 11 is moved, the zeroing device 21 slides along the control cam 20 with an actuating pin 21′ in order to move the number wheel 2 into a zero position by engaging with a return arm 44 on a heart-shaped control cam 32 of the number wheel 2.

An actuating device, characterized in that an engagement region 29 of a latch 6 formed by a rocker is moved out of an engagement region 28 of the adjustment sleeve 3 by means of a tappet 22 from a control cam 34, 35′ of the rotary knob 11 before the zeroing device 11 is moved.

An actuating device, characterized in that the adjustment sleeves 3 each form a first sleeve-shaped extension 13 which supports a number wheel 2 assigned to the adjustment sleeve 3 and each form a second sleeve-shaped extension 15 which rests against a first sleeve-shaped extension 13 of an adjustment sleeve 3 or against a stop 14 of the programming element 7, wherein a first sleeve-shaped extension 13 is acted upon by the spring element 12.

An actuating device, characterized in that the displacement element 22 is a tappet 22 that can be displaced by a control cam 34, 35′ of the rotary knob 11.

An actuating device, characterized in that the control cam 34, 35′ is formed by a control projection 35 of a control sleeve 10, which is fixed to the rotary knob 11 in such a way that it cannot rotate.

All disclosed features are essential to the invention (both individually and in combination with each other). The disclosure of the application hereby also includes the full content of the associated/attached priority documents (copy of the previous application), also for the purpose of incorporating features of these documents into the claims of the present application. Even without the features of a referenced claim, the subclaims characterize, with their features, independent inventive developments of the prior art, in particular for the purpose of filing divisional applications on the basis of these claims. The invention specified in each claim may additionally have one or more of the features specified in the above description, in particular those marked with reference numbers and/or specified in the list of reference numbers. The invention also relates to designs in which some of the features mentioned in the above description are not realised, in particular if they are recognisably dispensable for the respective intended use or can be replaced by other technically equivalent means.

List of reference numbers

| | |
|---|---|
| 1 | Housing |
| 2 | Number wheel |
| 3 | Adjustment sleeve |
| 4 | Clutch pin |
| 5 | Coupling opening |
| 6 | Rocker, locking device |
| 7 | Programming slider |
| 8 | Protrusion/projection |
| 8′ | Bevel |
| 9 | Recess |
| 10 | Control body, control sleeve |
| 11 | Rotary knob, actuating element |
| 12 | Spring element |
| 13 | Extension |
| 14 | Stop |
| 15 | Continuation |
| 16 | Switch button |
| 17 | Spring element |
| 18 | Cylindrical surface |
| 18′ | Lower edge |
| 19 | Control cam |
| 20 | Control cam |
| 21 | Zero adjuster |
| 21 | Actuating pin |
| 22 | Tappet |
| 23 | Control cam |
| 23 | Control cam |
| 23 | Recess |
| 24 | Bar |
| 25 | Recess |
| 26 | Flank |
| 26 | Cross |
| 27 | Spring |
| 28 | Indentation |
| 29 | Bulge |
| 30 | Axis |
| 31 | Housing wall |
| 32 | Heart curve |
| 33 | Heart curve |
| 34 | Control angle |
| 34′ | Control angle |
| 35 | Control projection |
| 35′ | Control flank |
| 36 | Spring element |
| 37 | Frame leg |
| 38 | Additional lock |
| 39 | Actuating element |
| 39′ | Actuating pin |
| 40 | Projection |
| 41 | Cylinder core |
| 42 | Axle |
| 43 | Arm |
| 44 | Return arm |
| 45 | Axle |
| 46 | Leaf spring element |
| 47 | Spring arm |
| 47′ | Protrusion |
| 48 | Recess |
| 48′ | Floor space |
| 49 | Base |
| 50 | Base body |

1. An actuating device for a lock with adjustment sleeves (3) arranged one behind the other in an axial direction, each cooperating with a number wheel (2), which are coupled to each other in a locking position in which the actuation of an actuating element (11) is locked, wherein the adjustment sleeves (3) can be brought into a release position in an opening combination in conjunction with a rotation of the number wheels (2) into an opening combination, in which the actuating element (11) can be actuated, wherein the number wheels (2) are uncoupled from the adjustment sleeves (3) in a programming position for changing the opening combination, comprising a programming element (7) which blocks the actuation of the actuating element (11) in the programming position and which, when moving from the programming position to an actuating position in which the adjustment sleeves (3) are coupled to the number wheels (2), releases the blockage of the actuating element (11).

2. The actuating device according to claim 1, wherein the programming element (7) is a slider which is movable in the axial direction and has a switch button (16) protruding from a housing (1).

3. The actuating device according to claim 1, wherein the programming element (7) is acted upon by a spring element (12) in the programming position and/or forms a projection (8) which, in the programming position, rests in a recess (9) of a control body (10).

4. The actuating device according to claim 3, wherein the control body (10) is a control sleeve (10) connected in a rotationally fixed manner to a rotary knob (11) forming the actuating element, whereby the rotary knob (11) can be rotationally locked by a projection (8) of the programming element (11) engaging in the recess (9) of the control sleeve (10).

5. The actuating device according to claim 4, wherein the control sleeve (10) has a cylindrical surface (18) which connects to the recess (9) in the circumferential direction around an axis of rotation of the rotary knob (11) and on which the projection (8) slides along when the rotary knob (11) is rotated from an open position into the locking position.

6. The actuating device according to claim 4, wherein the control sleeve (10) has a control cam (19) which is designed in such a way that the projection (8) sliding along the control cam (19) when the rotary knob (11) is rotated from the locked position into the open position (8) sliding along the control cam (19) when the rotary knob (11) is turned from the locked position to the open position displaces the control sleeve (10) axially against a restoring force of a spring element (17) in such a way that the projection (8) passes under an edge (18′) of the control sleeve (10), thereby changing the programming element (7) from the operating position to the programming position.

7. The actuating device according to claim 6, wherein the actuating device is configured such that, after the programming element (7) has been moved into the programming position, when the rotary knob (11) is turned further in the direction of the open position, a further control cam (20) of the rotary knob (11) displaces a zeroing device (21) with which the adjustment sleeves (3) are moved into the release position and the number wheels (2) decoupled from them are moved into a zero position.

8. The actuating device according to claim 7, wherein the actuating device is configured such that, when the rotary knob (11) is moved, the zeroing device (21) slides along the control cam (20) with an actuating pin (21′) along the control cam (20) in order to move the number wheel (2) into a zero position by engaging with a return arm (44) on a heart-shaped control cam (32) of the number wheel (2).

9. The actuating device according to claim 4, wherein the actuating device is configured such that an engagement region (29) of a latch (6) formed by a rocker is moved away from an engagement region (28) of the adjustment sleeve (3) by means of a tappet (22) of a control cam (34, 35′) of the rotary knob (11) before the zero position adjuster (11) is moved by means of a tappet (22).

10. The actuating device according to claim 1, wherein the adjustment sleeves (3) each form a first sleeve-shaped extension (13) which supports a number wheel (2) assigned to the adjustment sleeve (3) and each form a second sleeve-shaped extension (15) which rests against a first sleeve-shaped extension (13) of an adjacent adjustment sleeve (3) or against a stop (14) of the programming element (7), wherein a first sleeve-shaped extension (13) is acted upon by the spring element (12).

11. An actuating device for a lock with adjustment sleeves (3) arranged axially one behind the other, each cooperating with a number wheel (2), which are coupled to each other in a locking position in which the actuation of an actuating element (11) is locked, wherein the adjustment sleeves (3) can be brought into a release position by turning the number wheels (2) into an opening combination, in which the actuating element (11) can be actuated, wherein the number wheels (2) are decoupled from the adjustment sleeves (3) in a programming position for changing the opening combination, with a locking device (6) which rests with an engagement region (29) on an engagement region (28) of the adjustment sleeve (3), with a zeroing device (21) which, when the actuating element (11) is actuated, moves the adjustment sleeves (3) into the release position and the number wheels (2) decoupled from them into a zero position, and with a displacement element (22) which, before the zeroing device (21) is displaced, moves the engagement region (29) of the locking device (6) out of the engagement region (28) of the adjusting bushings (3), wherein the displacement element (22) is a tappet (22) which is displaceable by a control cam (34, 35′) of the actuating element (11).

12. The actuating device according to claim 11, wherein the control cam (34, 35′) is formed by a control projection (35) of a control sleeve (10) which is fixed to the actuating element (11) so as to be non-rotatable.

13. (canceled)
